(19) United States
(12) Patent Application Publication
(10) Pub. No.: US 2010/0215186 A1
(43) Pub. Date: Aug. 26, 2010

(54) SHAREABLE HEADPHONE SYSTEM WITH DETACHABLE EARBUDS

(75) Inventor: PAULINE F. CHANG, Los Angeles, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Playa Vista, CA (US)

(21) Appl. No.: 12/713,158

(22) Filed: Feb. 25, 2010

Related U.S. Application Data
(60) Provisional application No. 61/155,476, filed on Feb. 25, 2009.

(51) Int. Cl. H04R 1/10

(52) U.S. Cl. 381/74

(57) ABSTRACT

Various embodiments disclose a portable device accessory configured to couple to a source. The portable device accessory can include: (a) a first umbilical cable, the first umbilical cable having: (1) a first input, the first input configured to couple to the source and receive a source signal; (2) a first electrical cable, the first electrical cable coupled to the first input and configured to receive the source signal from the first input; (3) a first splitter, the first splitter configured to couple to the first electrical cable, receive the source signal from the first electrical cable and produce two or more split signals wherein each split signal of the two or more split signals is substantially similar to the source signal; and (4) two or more first output source connectors, each first output source connector of the two or more first output connectors coupled to the first splitter and configured to receive a split signal of the two or more split signals; and (b) a speaker array, the speaker array including a two or more transducer modules, each transducer module coupled to a different one of the two or more first output source connectors and configured to receive a different one of the two or more split signals from the different one of the two or more first output source connectors, each transducer module of the two or more transducer modules further configured to produce an output signal. Other embodiments and related methods are also disclosed herein.

### CROSS REFERENCE TO RELATED APPLICATION

This application claims priority to U.S. Provisional Patent Application 61/155,476 filed on Feb. 25, 2009, the contents of which are incorporated herein by reference.

### FIELD OF THE INVENTION

This invention relates generally to speaker systems, and relates, more particularly, to portable speaker apparatuses and related methods.

### BACKGROUND

The portable audio market has changed dramatically in the past several years. Recent trends have focused on the improvement of overall sound quality of portable devices and portable speaker devices. Some of the improvements have occurred in the source of the audio. For example, portable CD audio players and MP3 audio players have garnered increasing shares of the portable market in comparison to more conventional, generally lower sound quality, cassette players, and radio sources. While focus on such sources has helped the overall perceived sound quality, further improvements have been somewhat limited by portability constraints.

Portable audio products find wide usage in society. These audio products are often employed for work and personal use, e.g., at the office or home, as well as during travel in the car, in a park, garage, or hotel room, or even in business presentations using a laptop computer. The required portability of these audio devices limits the overall size and weight of the system and hence the types and sizes of the speaker drivers and enclosures used. Some conventional portable audio products employ headphones or earbuds to accommodate portability in sound producing means. Unfortunately, employing headphones or earbuds results in a singular listening experience. One alternative is to share one channel of an earbud or headphone. However, this is typically not an acceptable solution.

Therefore, a need exists in the art to develop portable and usable listening apparatuses and related methods that address such limitations of the current technology.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates an exemplary system for providing user controlled audio entertainment from a portable device accessory coupled to a mobile media device, in accordance with the subject matter described herein.

FIG. 2 illustrates another exemplary system for providing user controlled audio entertainment from a portable device accessory coupled to a mobile media device, in accordance with the subject matter described herein.

FIG. 3 illustrates yet another exemplary system for providing user controlled audio entertainment from a portable device accessory coupled to a mobile media device, in accordance with the subject matter described herein.

FIG. 4 illustrates still yet another exemplary system for providing user controlled audio entertainment from a portable device accessory coupled to a mobile media device, in accordance with the subject matter described herein.

FIG. 5 illustrates a method of manufacturing a system for providing user controlled audio entertainment from a portable device accessory coupled to a mobile media device, in accordance with the subject matter described herein.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

Various embodiments disclose a portable device accessory configured to couple to a source. The portable device accessory can include: (a) a first umbilical cable, the first umbilical cable having: (1) a first input, the first input configured to couple to the source and receive a source signal; (2) a first electrical cable, the first electrical cable coupled to the first input and configured to receive the source signal from the first input; (3) a first splitter, the first splitter configured to couple to the first electrical cable, receive the source signal from the first electrical cable and produce two or more split signals wherein each split signal of the two or more split signals is substantially similar to the source signal; and (4) two or more first output source connectors, each first output source connector of the two or more first output connectors coupled to the first splitter and configured to receive a split signal of the two or more split signals; and (b) a speaker array, the speaker array including a two or more transducer modules, each transducer module coupled to a different one of the two or more first output source connectors and configured to receive a different one of the two or more split signals from the different one of the two or more first output source connectors, each transducer module of the two or more transducer modules further configured to produce an output signal

Some embodiments disclose a speaker system configured to couple to an audio source. The speaker system can include: (a) an umbilical cable having (1) two or more output source connectors; (2) a source jack configured to received an audio signal from the audio source and coupled to the two or more output source connectors such that each of the two or more output connectors receive the audio signal from the source jack. The two or more output source connectors are configured to couple to two or more transducers. The umbilical cable is configured such that two or more output connectors provide stereo audio signals to the two or more transducers if the two or more transducers are configured to receive the stereo audio signals. The umbilical cable is configured such that two or more output connectors provide mono audio signals to the two or more transducers if the two or more transducers are configured to receive the mono audio signals.

Further embodiments disclose a method of manufacturing a portable device accessory. The method can include: providing a first umbilical cable, the umbilical cable having: (a) a first input, the first input configured to couple to a source and receive a source signal from the source; (b) a first splitter, the first splitter configured to receive the source signal from the first input and produce two or more split signals wherein each split signal is substantially similar to the source signal; and (c) two or more first output source connectors; providing at least a first array of speakers, the first array of speakers includes two or more transducer modules, each transducer module coupled to one of the two or more first output source connectors and configured to receive one of the two or more split signals from the one of the two or more first output source connectors, each transducer module further configured to produce an output signal; and coupling the first array of speakers to the two or more output source connectors of the first umbilical cable.

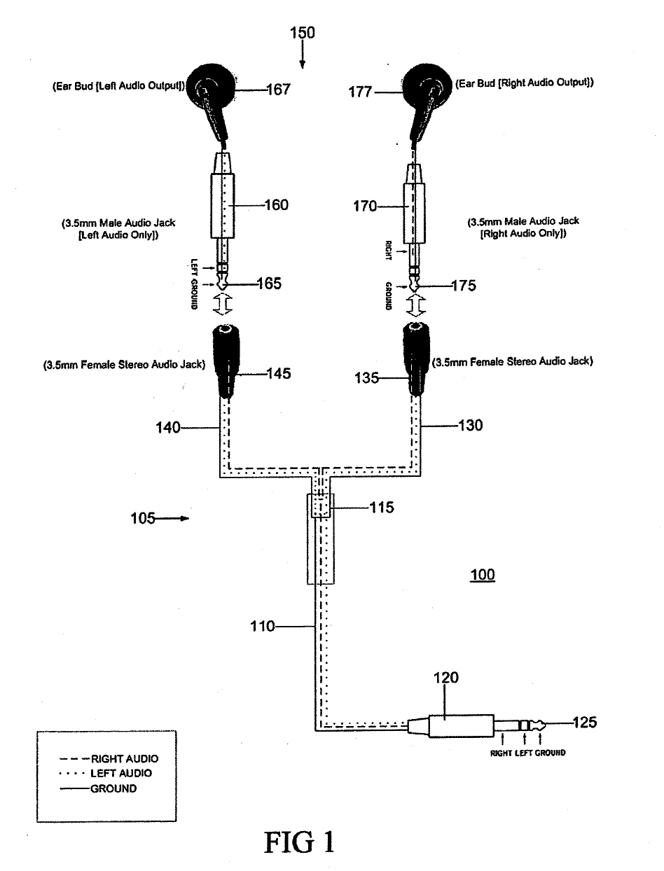

FIG. 1 illustrates an embodiment of an exemplary system for providing shareable headphones and including detachable earbuds. The exemplary system can permit sharing stereo music or other stereo audio sounds, instead of sharing only the right channel of a stereo recording or sharing only the left channel of a stereo recording. FIG. 1 includes shareable headphone system 100 (also called shareable headphones) including umbilical cable 105 and transducer module 150. Umbilical cable 105 can include shareable electrical cable 110 that is electrically coupled to right cable 130 and left cable 140. Transducer module 150 includes a left channel detachable transducer assembly 160, a right channel detachable transducer assembly 170, and transducer housings 167 and 177.

Shareable electrical cable 110 can be implemented as any suitable data signal carrying cable, such as, for example a shielded wired pair configuration contained within a suitably insulated material, for example nylon, (polytetrafluoroethene) (“PTFE”), silicon, glass, ceramics, asbestos, cotton or like fabric, a fibrous material (e.g., fiberglass, paper or pulp, carbon, etc.), polyethylene, neoprene, polyvinyl chloride (“PVC”), elastic hydrocarbon polymer or some such other thermoplastic polymer using a phthalate, as well as other plasticizers and the like. Umbilical cable 105 further includes signal splitter or Y-fan-out 115, output source connectors 135 and 145, and source connector 120 having a source jack 125. Y-fan-out 115 includes an input portion that is electrically coupled to source jack 125 (described below) via source connector 120 and an output portion that is electrically coupled to output source connector 135 and output source connector 145. In this embodiment, Y-fan-out 115 is configured to receive a data signal from source connector 120 (described below), split the received data signal and provide a substantially similar data signal (i.e., split signals) to output source connector 135 and output source connector 145. In another embodiment, shareable electrical cable 110 can be implemented as any suitable data signal carrying cable including a pair of shielded wired pairs contained within a suitably insulated material. In this embodiment, each of the shielded wired pairs carries a substantially similar data signal that is provided from a source to a source jack 125 configured to simultaneously receive multiple data signals, for example, a stereo data signal. In another embodiment, source jack 125 configured to receive a mono signal.

In some embodiments, output source connectors 135 and 145 are substantially similar to each other and each is a female receptor. In some examples, output source connectors 135 and 145 can include a jack receiver portion having a sleeve coupled to a plurality of pins (not shown) within connectors 135 and 145 that are suitable for receiving a data signal from Y-fan-out 115 and passing the received data signal to an associated channel transducer. In other embodiments, output source connectors 135 and 145 are each configured as male jacks wherein each output source connector is configured substantially similar to source jack 125 (described below). Although umbilical cable 105 can be described as a stereo cable, umbilical cable 105 can also be a mono cable. Other aspects of shareable headphone system 100 can also be modified for a mono system.

As described above, source connector 120 includes source jack 125 which further includes a tip, a ring and a sleeve (not shown) as well as a plurality of pins (not shown) within source connector 120 that are suitable for receiving a data signal (i.e., a source signal) from a source and passing the received data signal to wiring within source connector 120. In this embodiment, source jack 125 is a TRS (tip, ring, and sleeve) connector. In other embodiments, source connector 120 can be implemented as a TRRS (tip, ring, ring, and sleeve) connector, a TS (tip and sleeve) connector, a coaxial connection (RCA), an XLR connector, fan-out wiring, and the like. In some embodiments, the data signal may contain an audio portion, a video portion, or a combination thereof. The data signal may be comprised of analog data, digital data, or a combination thereof. The data signal may be configured to conduct direct current (DC), alternating current (AC) or a combination thereof. Audio and/or video connectors are well known in the art and will not be discussed further.

Left channel transducer assembly 160 and a right channel transducer assembly 170 each include an associated transducer jack and transducer housing. Transducer housing 167 includes a pair of wires contained within a suitably insulated material, for example nylon, PTFE, silicon, glass, ceramics, asbestos, cotton or like fabric, a fibrous material (e.g., fiberglass, paper or pulp, carbon, etc.), polyethylene, neoprene, PVC, elastic hydrocarbon polymer or some such other thermoplastic polymer using a phthalate, as well as other plasticizers and the like. Transducer housing 167 is an acoustical chamber configured to house a transducer (not shown) that is electrically coupled to transducer jack 165 via the aforementioned pair of wires. In some examples, transducer housing 167 can be ergonomically configured to interface with a human ear. Left channel transducer assembly 160 includes transducer jack 165. In various embodiments, transducer jack 165 can have a tip, a ring and a sleeve (not shown) as well as a plurality of pins (not shown) within transducer assembly 160 that are suitable for receiving a data signal from a suitable source and passing the received data signal to the transducer of transducer housing 167 via the pair of wires. Transducer jack 165 can be configured to utilize the tip and ring of the aforementioned available tip, ring and sleeve thereby providing a dedicated left channel signal to transducer housing 167 for use by the transducer therein.

Similarly, right channel transducer assembly 170 includes transducer jack 175. Transducer jack 175 can have a tip, a ring and a sleeve (not shown) as well as a plurality of pins (not shown) within transducer assembly 170 that are suitable for receiving a data signal from a suitable source and passing the received data signal to the transducer of transducer housing 177 via the pair of wires. Transducer jack 175 can be configured to utilize the tip and sleeve of the aforementioned available tip, ring, and sleeve thereby providing a dedicated right channel signal to transducer housing 177 for use by the transducer therein. In other embodiments, left channel transducer assembly 160 and right channel transducer assembly 170 are each configured as a male jack that includes a jack portion having a sleeve coupled to a plurality of pins (not shown) within transducer assemblies 160 and 170 that are suitable for receiving a data signal from an associated female receptor of umbilical cable 105.

In operation, source connector 120 interfaces with a source (not shown) via source jack 125 and receives a data signal that is passed to Y-fan-out 115 via shareable electrical cable 110. The data signal is then passed to output source connectors 135 and 145 via right cable 130 and left cable 140, respectively. Each output source connector in turn can pass the data signal to an associated transducer assembly 160 and 170 when the channel transducer assembly 160 and 170 are mechanically and electrically coupled to the associated source connector. Each of the channel transducer assemblies 160 and 170 pass a dedicated channel signal to an associated transducer housing, which broadcasts a dedicated channel signal to, for example, a user's ear.

In one embodiment, channel transducer assemblies 160 and/or 170 can also house: (a) a portion of the wires coupling transducer jacks 165 and 175 to the transducers of transducer housings 167 and 177; and (b) a cable retraction mechanism for storing an unused length of the wires.

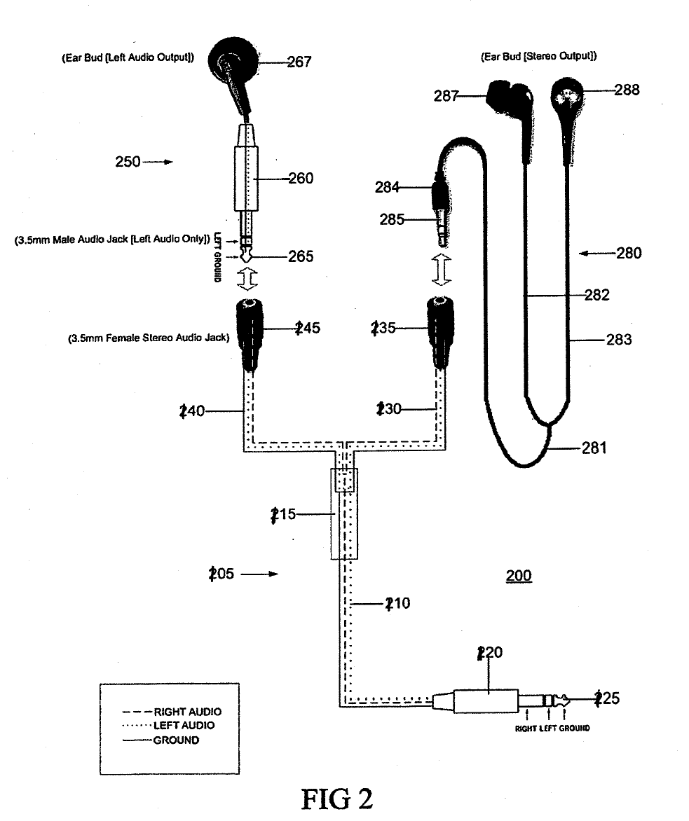

FIG. 2 illustrates another embodiment of an exemplary system for providing shareable headphones and including detachable earbuds. FIG. 2 includes headphone system 200 (also called shareable headphones) including umbilical cable 105, transducer module 250, and shareable headphone module 280. Umbilical cable 105 includes electrical cable 110 that is electrically coupled to right cable 130 and left cable 140 via Y-fan-out 115 wherein each cable is in electrical communication with an associated output source connector 135 and 145, respectively. Umbilical cable 105 additionally includes source connector 120. Source connector 120 can have source jack 125 which includes a tip, a ring and a sleeve (not shown) as well as a plurality of pins (not shown) within source connector 120 that are suitable for receiving a data signal from a source and passing the received data signal to wiring within source connector 120.

In this embodiment, source jack 125 can be a TRS connector. Elements similarly numbered and described in FIG. 1 function in a substantially similar way. In FIG. 2, headphone system 200 may include other elements not relevant to the present discussion.

In some embodiments, transducer module 250 includes a left channel detachable transducer 260, a jack 265, and a transducer housing 267 having a transducer. In other embodiments, detachable transducer 260 is implemented as a right channel detachable transducer.

As illustrated in FIG. 2, shareable headphone module 280 can include: (a) shareable electrical cable 281; (b) left cable 282; (c) right cable 283; (d) headphone connector 284 which includes headphone jack 285; (d) left channel headphone transducer housing 287; and (e) right channel headphone transducer housing 288. Shareable headphone module 280 can be implemented as any suitable headphone module. In one embodiment, shareable electrical cable 281 is configured to receive a data signal from headphone connector 284 (described below), split the received data signal and provide a dedicated left channel signal to the transducer of left channel headphone transducer housing 287 and a dedicated right channel signal to the transducer of right channel headphone transducer housing 288. In this embodiment, headphone connector 284 of shareable headphone module 280 includes headphone jack 285 which further can include a tip, a ring and a sleeve (not shown) as well as a plurality of pins (not shown) within headphone connector 284 that are suitable for receiving a data signal from a source (e.g., output source connector 135) and passing the received data signal to wiring within headphone module 280. Headphone jack 285 can be called a TRS connector. Audio and/or video connectors are well known in the art and will not be discussed further.

Left channel headphone transducer housing 287 and right channel headphone transducer housing 288 each include an associated transducer. Each transducer within each housing is electrically coupled to a pair of wires (not shown) contained within a different one of right cable 282 and left cable 283 and subsequently electrical cable 281. Cables 281, 282, and 283 are manufactured from a suitably insulated material, for example nylon, PTFE, silicon, glass, ceramics, asbestos, cotton or like fabric, a fibrous material (e.g., fiberglass, paper or pulp, carbon, etc.), polyethylene, neoprene, PVC, elastic hydrocarbon polymer or some such other thermoplastic polymer using a phthalate, as well as other plasticizers and the like.

In FIG. 2, each transducer housing 287 and 288 is an acoustical chamber configured to receive a transducer (not shown) that is electrically coupled to headphone jack 285 via the aforementioned pair of wires. Additionally, each transducer housing is ergonomically configured to interface with a human ear.

In operation, when headphone jack 285 is mechanically coupled to output source connector 135, headphone jack 285 receives a data signal that is passed to left channel headphone transducer housing 287 and right channel headphone transducer housing 288 via left cable 282 and right cable 283, respectively. Each of the channel headphone transducer housings 287 and 288 broadcasts a dedicated channel signal to, for example, a user's ear via the transducers within such housings. In one embodiment, output source connector 135 provides a stereo output, and output source connector 145 provides a single channel output, for example, a left audio output when left channel jack 265 is mechanically and electrically coupled to output source connector 145.

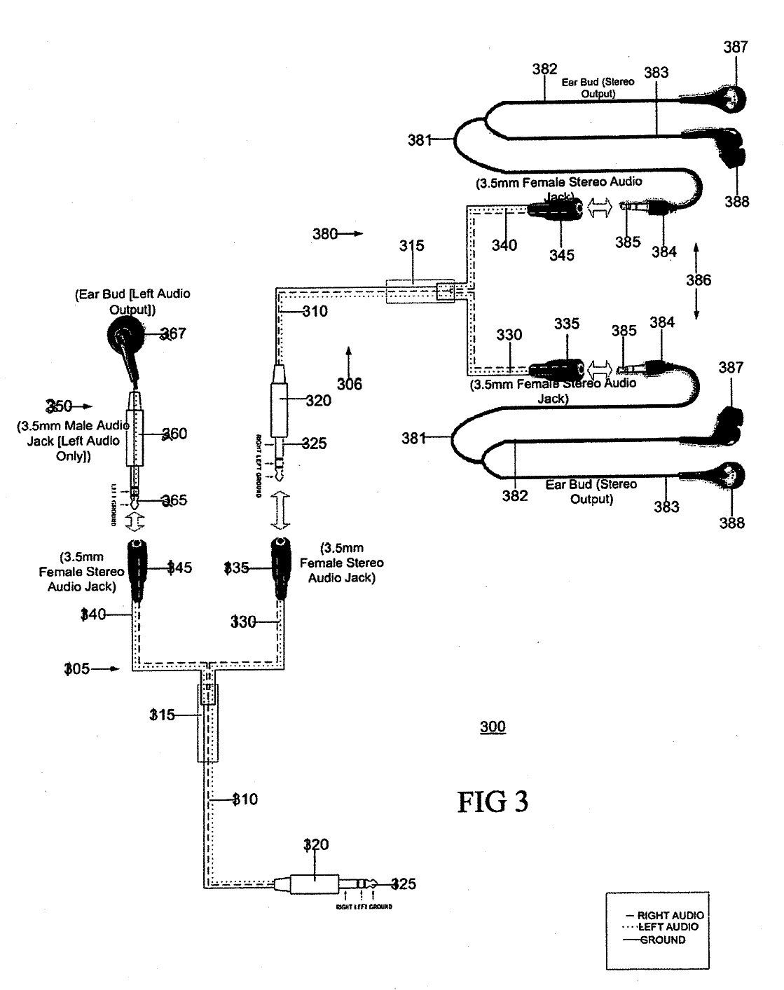

FIG. 3 illustrates another embodiment of an exemplary system for providing shareable headphones and including detachable earbuds. FIG. 3 includes headphone system 300 (also called shareable headphones) including umbilical cable 105, transducer module 250, and shareable headphone module 380. Umbilical cable 105 includes electrical cable 110 that is electrically coupled to right cable 130 and left cable 140 via Y-fan-out 115 wherein each cable is in electrical communication with an associated output source connector 135 and 145, respectively. Umbilical cable 105 additionally includes source connector 120. Source connector 120 can have source jack 125 which includes a tip, a ring and a sleeve (not shown) as well as a plurality of pins (not shown) within source connector 120 that are suitable for receiving a data signal from a source and passing the received data signal to wiring within source connector 120. Transducer module 250 includes a left channel detachable transducer 260, a jack 265, and a transducer housing 267 having a transducer. Elements similarly numbered and described in FIGS. 1 and 2 function in a substantially similar way. Similarly, elements numbered with the same last two significant digits as described in FIGS. 1 and 2 can function in a substantially similar way. In FIG. 3, headphone system 300 can include other elements not relevant to the present discussion.

Shareable headphone module 380 includes an umbilical cable 306 and one or more headphone modules 386. Umbilical cable 306 includes electrical cable 310 that is electrically coupled to right cable 330 and left cable 340 via Y-fan-out 315 wherein each cable is in electrical communication with an associated output source connector 335 and 345. Umbilical cable 306 additionally includes source connector 320 having source jack 325. Source jack 325 can include a tip, a ring and a sleeve (not shown) as well as a plurality of pins (not shown) within source connector 320 that are suitable for receiving a data signal from a source and passing the received data signal to wiring within source connector 320.

Each headphone module 386 can include: (a) shareable electrical cable 381; (b) left cable 382; (c) right cable 383; (d) headphone connector 384 which includes headphone jack 385; (e) left channel headphone transducer housing 387; and (f) right channel headphone transducer housing 388. Each of headphone modules 386 provides substantially similar functionality and can be implemented as the same make and model of headphone or as different sets of headphones. In one embodiment, headphone connector 384 of shareable headphone module 380 includes headphone jack 385 which further includes a tip, a ring and a sleeve (not shown) as well as a plurality of pins (not shown) within headphone connector 384 that are suitable for receiving a data signal from a source (e.g., output source connector 135) and passing the received data signal to wiring within headphone module 380. Headphone jack 385 can be a TRS connector in some examples.

In this embodiment, each shareable electrical cable 381 is configured to receive a data signal from headphone connector 384, split the received data signal and provide a dedicated left channel signal to a transducer within left channel headphone transducer housing 387 and a dedicated right channel signal to a transducer within right channel headphone transducer housing 388.

In operation, when source jack 325 of umbilical cable 306 is mechanically coupled to output source connector 135 of umbilical cable 105, umbilical cable 306 receives a data signal that is passed to Y-fan-out 315 of umbilical cable 306 and then on to output source connectors 335 and 345 of umbilical cable 306 while retaining substantially all of its characteristics. Continuing the example, when headphone jack 385 of either or both headphone modules 386 is mechanically coupled to output source connector 335 of umbilical cable 306, headphone jack 385 receives a data signal, for example, a stereo signal, that is passed to left channel headphone transducer housing 387 and right channel headphone transducer housing 388 via left cable 382 and right cable 383, respectively. Each of the channel headphone transducer housings 387 and 388 broadcasts a dedicated channel signal to, for example, one or more users' ears via the transducers within such housings.

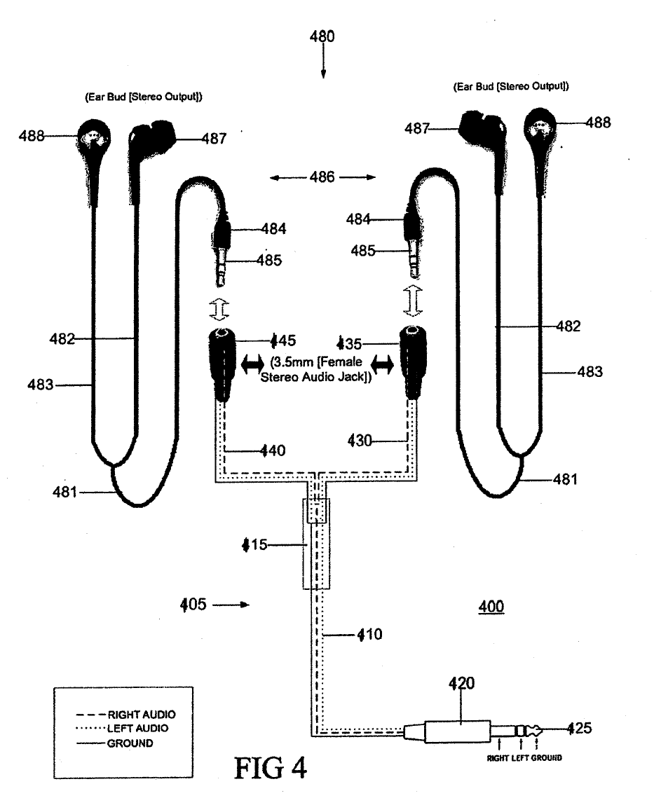

FIG. 4 illustrates still another embodiment of an exemplary system for providing shareable headphones and including detachable earbuds. FIG. 4 includes headphone system 400 (also called shareable headphones) including umbilical cable 105 and shareable headphone module 480. Umbilical cable 105 includes electrical cable 110 that is electrically coupled to right cable 130 and left cable 140 via Y-fan-out 115 wherein each cable is in electrical communication with an associated output source connector 135 and 145, respectively. Umbilical cable 105 additionally includes source connector 120 having source jack 125 which includes a tip, a ring and a sleeve (not shown) as well as a plurality of pins (not shown) within source connector 120 that are suitable for receiving a data signal from a source and passing the received data signal to wiring within source connector 120. Elements similarly numbered and described in FIGS. 1-3 function in a substantially similar way. Similarly, elements numbered with the same last two significant digits as described in FIGS. 1-3 can function in a substantially similar way. In FIG. 4, headphone system 400 may include other elements not relevant to the present discussion.

Shareable headphone module 480 includes one or more headphone modules 486. Each headphone module 486 includes: (a) shareable electrical cable 481; (b) left cable 482, right cable 483; (c) headphone connector 484 which includes headphone jack 485; (d) left channel headphone transducer housing 487; and (e) right channel headphone transducer housing 488. Each of headphone modules 486 provides substantially similar functionality and can be implemented as the same make and model of headphone or as different sets of headphones.

In one embodiment, headphone connector 484 of shareable headphone module 480 includes headphone jack 485. Headphone jack 485 can include a tip, a ring and a sleeve (not shown) as well as a plurality of pins (not shown) within headphone connector 484 that are suitable for receiving a data signal from a source (e.g., output source connector 135) and passing the received data signal to wiring within headphone connector 480. Headphone jack 485 can be a TRS connector in some examples. In this embodiment, each shareable electrical cable 481 is configured to receive a data signal from headphone connector 484, split the received data signal and provide a dedicated right channel signal to a transducer within right channel headphone transducer housing 487 and a dedicated left channel signal to a transducer within left channel headphone transducer housing 488.

In operation, when headphone jack 485 of either or both headphone modules 486 is mechanically coupled to output source connector 135 of umbilical cable 105, headphone jack 485 receives a data signal that is passed to right channel headphone transducer housing 487 and left channel headphone transducer housing 488 via right cable 482 and left cable 483, respectively. Each of the channel headphone transducer housings 487 and 488 broadcasts a dedicated channel signal to, for example, one or more users' ears via the transducers within such housings.

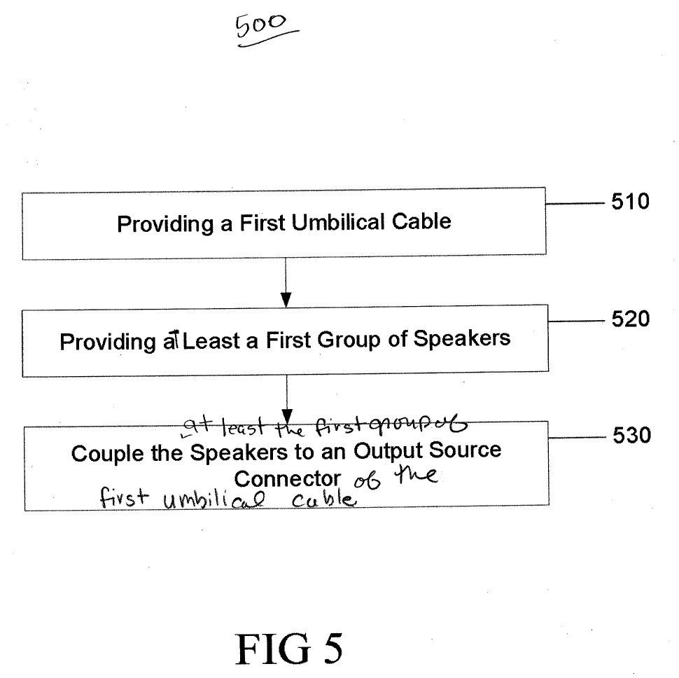

FIG. 5 illustrates an example of a method 500 of manufacturing a portable device according to an embodiment. Method 500 of FIG. 5 includes a process 510 of providing a first umbilical cable. The first umbilical cable can be the same as or similar to umbilical cable 105 of FIGS. 1-4 and/or umbilical cable 310 of FIG. 3. In some embodiments, the first umbilical cable include an output source connector and a source jack

Next, method 500 of FIG. 5 includes a process 520 of providing at least a first array of speakers. For example, the first array of speakers can be similar or identical to transducer housings 167 or 177 of FIG. 1, transducer housings 267, 287, and/or 288 of FIG. 2, transducer housings 367, 387, and/or 388 of FIG. 3, and/or transducer housings 487 or 488 of FIG. 4. It should be noted that the order of processes 510 and 520 can be reversed, or process 510 and process 520 can be performed at the same time.

Method 500 continues with a process 530 of coupling the at least one array of speakers to an output source connector of the first umbilical cord. As an example, FIGS. 1-4 illustrate one or more speakers coupled to an output source connector of an umbilical cord.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A portable device accessory configured to couple to a source, the portable device accessory comprising:
a first umbilical cable, the first umbilical cable comprising:
a first input, the first input configured to couple to the source and receive a source signal;
a first electrical cable, the first electrical cable coupled to the first input and configured to receive the source signal from the first input;
a first splitter, the first splitter configured to couple to the first electrical cable, receive the source signal from the first electrical cable and produce two or more split signals wherein each split signal of the two or more split signals is substantially similar to the source signal; and
two or more first output source connectors, each first output source connector of the two or more first output connectors coupled to the first splitter and configured to receive a different split signal of the two or more split signals; and
a speaker array, the speaker array including a two or more transducer modules, each transducer module coupled to a different one of the two or more first output source connectors and configured to receive a different one of the two or more split signals from the different one of the two or more first output source connectors, each transducer module of the two or more transducer modules further configured to produce an output signal.

2. The portable device accessory of claim 1, wherein the source signal is a multi-channel signal.

3. The portable device accessory of claim 1, wherein the two or more split signals are selected from the group consisting of: a stereo signal, a mono signal, an analog signal, a digital signal, or an analog or digital signal.

4. The portable device accessory of claim 1, wherein:
the two or more transducer modules comprise:
a first transducer module, the first transducer module including:
a first transducer jack configured to receive a first split signal of the two or more split signals from a first output source connector of the two or more first output source connectors and produce a dedicated first channel signal at least partially based on a configuration of the first transducer jack;
a first transducer assembly coupled to the first transducer jack, the first transducer assembly configured to receive the dedicated first channel signal from the first transducer jack; and
a first transducer housing coupled to the first transducer assembly, the first transducer housing configured to receive the dedicated first channel signal from the first transducer assembly and provide the dedicated first channel signal to a user.

5. The portable device accessory of claim 4, wherein:
the two or more transducer modules further comprise:
a second transducer module, the second transducer module including;
a second transducer jack configured to receive a second split signal of the two or more split signals from a second output source connector of the two or more first output source connectors and produce a dedicated second channel signal at least partially based on a configuration of the second transducer jack;
a second transducer assembly coupled to the second transducer jack, the second transducer assembly configured to receive the dedicated second channel signal from the second transducer jack; and
a second transducer housing coupled to the second transducer assembly, the second transducer housing configured to receive the dedicated second channel signal from the second transducer assembly and provide the dedicated second channel signal to the user.

6. The portable device accessory of claim 5, wherein the two or more split signals are a stereo signal and the dedicated first channel signal is a right channel signal and the dedicated second channel signal is a left channel signal of the stereo signal.

7. The portable device accessory of claim 5, wherein the two or more split signals are a stereo signal and the dedicated first channel signal is a left channel signal of the stereo signal and the dedicated second channel signal is a right channel signal of the stereo signal.

8. The portable device accessory of claim 1, wherein:
the two or more transducer modules comprise:
a first headphone module, the first headphone module including:
a first headphone jack, the first headphone jack configured to couple to a first output source connector of the two or more first output source connectors, the first headphone jack additionally configured to receive a first split signal of the two or more split signals from the first output source connector of the two or more first output source connectors and produce a left channel signal and a right channel signal;
a first headphone cable, the first headphone cable coupled to the first headphone jack, the first headphone cable configured to receive the left channel signal and the right channel signal from the first headphone jack;
a left electrical cable, the left electrical cable coupled to the first headphone cable, the left electrical cable configured to receive the left channel signal from the first headphone cable;
a right electrical cable, the right electrical cable coupled to the first headphone cable, the right electrical cable configured to receive the right channel signal from the first headphone cable;
a left transducer housing, the left transducer housing coupled to the left electrical cable, the left transducer housing configured to receive the left channel signal from the left electrical cable and provide the left channel signal to a first user; and
a right transducer housing, the right transducer housing coupled to the right electrical cable, the right transducer housing configured to receive the right channel signal from the right electrical cable and provide the left channel signal to the first user.

9. The portable device accessory of claim 8, wherein:
the two or more transducer modules further comprise:
a first transducer module, the first transducer module including;
a first transducer jack configured to receive a second split signal of the two or more split signals from a second output source connector of the two or more first output source connectors and produce a dedicated first channel signal at least partially based on a configuration of the first transducer jack;
a first transducer assembly coupled to the first transducer jack, the first transducer assembly configured to receive the dedicated first channel signal from the first transducer jack; and
a first transducer housing coupled to the first transducer assembly, the first transducer housing configured to receive the dedicated first channel signal from the first transducer assembly and provide the dedicated first channel signal to a second user.

10. The portable device accessory of claim 9, wherein the two or more split signals are stereo signals and the dedicated first channel signal is a right channel signal.

11. The portable device accessory of claim 9, wherein the two or more split signals are stereo signals and the dedicated first channel signal is a left channel signal.

12. The portable device accessory of claim 1, further comprising:
a second umbilical cable coupled to a first output source connector of the two or more first output source connectors,
wherein:
the second umbilical cable comprises:
a second input, the second input configured to couple to the first output source connector of the two or more first output source connectors and receive a first split signal of the two or more split signals;
a second electrical cable, the second electrical cable coupled to the second input and configured to receive the first split signal of the two or more split signals;
a second splitter, the second splitter configured to couple to the second electrical cable, and configured to receive the first split signal of the two or more split signals and produce two or more second split signals; and
two or more second output source connectors, each second output source connector coupled to the second splitter and configured to receive a different one of the two or more second split signals; and
a speaker array, the speaker array including two or more transducer modules, each transducer module coupled to a different one of the two or more second output source connectors and configured to receive a different one of the two or more split signals from the different one of the two or more second output source connectors, each transducer module further configured to produce a second output signal.

13. The portable device accessory of claim 1, wherein:
the speaker array comprises headphones.

14. A speaker system configured to couple to an audio source, the speaker system comprising:
an umbilical cable comprising:
two or more output source connectors;
a source jack configured to received an audio signal from the audio source and coupled to the two or more output source connectors such that each of the two or more output source connectors receive the audio signal from the source jack,
wherein:
the two or more output source connectors are configured to couple to two or more transducers;
the umbilical cable is configured such that the two or more output source connectors provide stereo audio signals to the two or more transducers if the two or more transducers are configured to received the stereo audio signals; and
the umbilical cable is configured such that the two or more output source connectors provide mono audio signals to the two or more transducers if the two or more transducers are configured to receive the mono audio signals.

15. The speaker system of claim 14, further comprising:
the two or more transducers.

16. The speaker system of claim 15, wherein:
a first transducer of the two or more transducers comprises:
a first transducer jack configured to removably couple to the two or more output source connectors; and
two or more first transducer housings coupled to the first transducer jack and configured to provide the stereo audio signal to the user.

17. The speaker system of claim 16, further comprising:
a second transducer of the two or more transducers comprises:
a second transducer jack configured to removably couple to the two or more output source connectors; and
a second transducer housing coupled to the second transducer jack and configured to provide the mono audio signal to the user.

18. The speaker system of claim 15, further comprising:
a first transducer of the two or more transducers comprises:
a first transducer jack configured to removably couple to the two or more output source connectors; and
a first transducer housing coupled to the first transducer jack and configured to provide a right channel audio signal of the stereo audio signal to the user; and
a second transducer of the two or more transducers comprises:
a second transducer jack configured to removably couple to the two or more output source connectors; and
a second transducer housing coupled to the second transducer jack and configured to provide a left channel audio signal of the stereo audio signal to the user.

19. The speaker system of claim 18, further comprising:
a third transducer of the two or more transducers comprises:
a third transducer jack configured to removably couple to the two or more output source connectors; and
a third transducer housing coupled to the third transducer jack and configured to provide the mono audio signal to the user.

20. A method of manufacturing a portable device accessory, comprising:
providing a first umbilical cable, the first umbilical cable comprising:
a first input, the first input configured to couple to a source and receive a source signal from the source;
a first splitter, the first splitter configured to receive the source signal from the first input and produce two or more split signals wherein each split signal is substantially similar to the source signal; and
two or more first output source connectors;
providing at least a first array of speakers, the first array of speakers includes two or more transducer modules, each transducer module coupled to a different one of the two or more first output source connectors and configured to receive a different one of the two or more split signals from the different one of the two or more first output source connectors, each transducer module further configured to produce an output signal; and
coupling the first array of speakers to the two or more output source connectors of the first umbilical cable.
